(19) United States
(12) Patent Application Publication
(10) Pub. No.: US 2004/0197384 A1
(43) Pub. Date: Oct. 7, 2004

(54) Animal feed incorporating a humate to reduce manure odor

(76) Inventor: Merle McGrane, Ionia, IA (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/408,291

(22) Filed: Apr. 7, 2003

(51) Int. Cl. A23K 1/165; A23K 1/17

(52) U.S. Cl. 424/442; 426/635

(57) ABSTRACT

An animal feed composition utilizing a humate and/or a modified humate as an ingredient thereof to reduce the odor of manure. The humate and/or modified humate is incorporated with the animal feed in an amount of from about 0.05% to about 5% on a dry weight basis.

### BACKGROUND OF THE INVENTION

The present invention relates to animal feed, and more particularly to an improved animal feed composition and method to substantially reduce manure odor utilizing a humate or modified humate as an ingredient in the animal feed composition.

Animal feeds are generally produced with low cost by-product ingredients. These ingredients are often unpalatable, of low density, and have an inadequate nutrient profile. To correct these shortcomings, ingredients are combined into a mixture which is supplemented with the necessary vitamins, minerals, proteins and amino acids to meet the nutrient requirements of the animal's diet. This is normally accomplished during extrusion and/or compaction techniques which form pellets, blocks, or briquettes to be fed to the animal.

A significant portion of all feed consumed by animals is incompletely metabolized and consequently excreted as waste. The excreted waste from animals is typically collected and formed into manure which in turn is conventionally spread on soil as a fertilizer for gardens, farms, golf courses and the like since manure contains various nutrients such as nitrogen, phosphorous and potassium which are useful to plants. Unfortunately, animal manure also contains numerous malodorous compounds such as indole, skatole, mercaptan and various phenols. As a result, undesirable odors are released into the atmosphere during collection and storage of the manure as well as when the manure is applied to soil.

### SUMMARY OF THE INVENTION

It is an object of the present invention to provide an animal feed composition that provides an animal diet resulting in the production of reduced amounts of malodorous compounds.

It is another object of the present invention to provide an animal feed composition which reduces malodorous compounds while at the same time maintains an adequate nutrient profile for the animal.

These and other objects of the invention are accomplished by an animal feed composition and method of reducing manure odor wherein an animal feed utilizes a humate or modified humate as an ingredient thereof. By incorporating a humate or modified humate in the diet of an animal, manure produced by the animal contains reduced amounts of malodorous compounds. The animal feed composition may contain 0.05% to about 5% by weight on a dry weight basis of the humate or modified humate.

### DETAILED DESCRIPTION OF THE INVENTION

An animal feed composition incorporating a humate or modified humate used to reduce the odor of animal manure. The humate or modified humate may be incorporated with the feed in an amount of from about 0.05% to about 5%, preferably from about 0.1% to about 3%, and most preferably about 1%, on a dry weight basis.

The animal feed may be any organic meal normally employed to meet the dietary requirements of animals. Typically, such animal feed contains proteins, carbohydrates, vitamins, minerals such as zinc, iron and manganese, or any combinations thereof which are mixed together and subsequently formed into pellets, blocks or briquettes.

Examples of such organic meals include those which are primarily composed of corn, soybean meal, a corn/soybean meal mix, together with protein, vitamin and mineral supplements. Other ingredients typically utilized in animal feeds can also be incorporated in the present feed composition such as binders, anti-biotics and the like. Examples of commercially available organic meals include Egg Maker Complete, a poultry feed product of Land-O-Lakes AG Services, as well as Country Game and Turkey Grower, another poultry feed product which is available from Agwa, Inc. Examples of commercially available products fed to dairy cattle include Purina 32% Milk Chow, Land-O-Lakes “Peak Plus 37”, and Kent “Provider 38”. Examples of commercially available products fed to swine include Purina Hog Chow, Land-O-Lakes “Lean Grain 93”, and Kent “G.M Based 40%”. Each of the above commercially available products are typical examples of animal feeds with which the present humate or modified humate may be incorporated to reduce manure odor. Thus, any type of organic meal may be utilized as the base mix to which the humate or modified humate ingredient of the present invention may be incorporated.

The present invention is applicable to the diet of numerous animals, which herein is defined as including mammals and fowl. In particular, the diet may be employed with commercially significant mammals such as cows, poultry, swine, sheep, goats, laboratory rodents (e.g. rats, mice, hamsters and gerbils), fur bearing animals such as mink and fox, and zoo animals such as monkeys and apes, as well as domestic mammals such as cats and dogs. Typical commercially significant fowl include chickens, turkeys, ducks, geese, pheasants and quail.

Humates, as used here, refer to the alkaline extracts of humic acid bearing ores. Peat, lignites (e.g. leonardite), bituminous coal, brown coal, collinite, exinite, and sapropelic coal have been cited as sources of humates, and thus, can be considered humic acid bearing ores (Kirk-Othmer, “Encyclopedia of Chemical Technology”, 3rd Ed., vol. 14, John Wiley & Sons, 1981). Extraction of such ores with sodium hydroxide, potassium hydroxide and/or ammonium hydroxide yields the humates for use herein. A specific example of such an extraction is given by U.S. Pat. No. 4,319,041 where humic acid containing ores are mixed with water and caustic soda and extraction of the humic acids occur with agitation at pH 6.5-8.0. The preferred ore is leonardite due to its ready availability and relatively inexpensive cost. The mean particle size of the ore will normally be less than about 3 mm. Preferably, the mean particle size of the ore varies in the range of 10 to 1000 microns and most preferably, the mean particle size is in the range of 10 to 100 microns. Thus, finer particles of ore result in the reaction occurring with relative ease enabling the reaction to be completed in a relatively shorter period of time. The humates disclosed herein can also be obtained by precipitation from runoff water containing high organic contents as described in U.S. Pat. No. 5,213,692. A third source of such humates is the so-called artificial humates produced by the oxidative polymerization of quinones.

Modified humates, as used here, refer to humates obtained from oxidized coal as described in U.S. Pat. No. 4,912,256. In U.S. Pat. No. 4,912,256, coal is mixed with an aqueous medium to produce a slurry having a pH in the range of 4-9. The slurry thus produced is reacted with a gaseous oxidant such as air or oxygen under conditions of temperature and pressure for a time sufficient to cause the oxidation of the coal. Separation of the reaction product from the aqueous medium produces an oxidized coal containing humates.

Another oxidative process described in South African Patent No. 87/9232 involves oxidation of coal in the dry state in a fluid bed reactor. Coal with a particle size in the 10 micron to 3 mm range is heated to 150 to 300° C. under a partial pressure of oxygen for a time of 30 to 600 minutes to produce oxidized coals containing humates. No alkali is used in this process.

Yet another method for producing humates from oxidized coals is described in U.S. Pat. No. 5,004,831. The process involves mixing oxidized coal with aqueous alkali, heating the mixture to 100 to 180° C. under sufficient pressure to prevent evaporation of water, and maintaining the elevated temperature for a time sufficient to extract a substantial amount of the available humates.

Humates oxidized after isolation by extraction are also considered modified humates, as are sulfonated humates. Typical sulfonation reactions included in the preparation of the latter class of modified humates include reaction with sulfur dioxide as described in U.S. Pat. No. 4,052,868, concentrated sulfuric acid as described by Zhambal (Khim Tverd. Topl. (Moscow 1991, (2), 70-2), sodium sulfite as described by Sharanova et al (Khim Tverd. Topl. (Moscow) 1987, (3), 38-43), sodium sulfite and sodium bisulfite as described in Spanish Patent 495,426 and by sulfomethylation as described by Pobedonostseva et al (Khim Tverd. Topl. (Moscow) 1978, (6), 97-102).

The humates and modified humates disclosed herein are heterocyclic in nature and, the chemical structure of these substances enable them to function as anti-oxidants. Since many of the decomposition reactions involved in the degradation of proteins involve free radical intermediates, the anti-oxidant properties of humates should contribute to their ability to reduce the formation of malodorous compounds such as indole, skatole, mercaptan and various other phenols.

The preferred humate is a humate generally referred to as a “High Desert Humate.” High Desert Humates contain 80% humic acids consisting of shorter chained humic acid molecules as well as fulvic acids (30% of the humic acid fraction, compared to 5% fulvic acids in other deposits). High Desert Humates are richer in oxygen; therefore they contain higher amounts of oxygen-containing functional groups such as carboxyls, phenols and quinones. High Desert Humates are high purity humates containing little or no “over-burden” which may be contaminated with lead, cadmium, strontium or other heavy lead metals.

It is believed that humates and/or modified humates form a protective film on the mucosal epithelial of the gastrointestinal (G.I.) tract and they discourage the growth of pathogens because they catalyze carbohydrate and protein metabolism of bacteria and viruses. They apparently augment the immune function by stimulating immune system receptor sites (Peyer's Patches) located in the intestinal tract, which protects animals from antigens and increases phagocytosis.

The humates and/or modified humates disclosed herein can be mixed directly into animal feed at the time of formulation, or mixed into the animal feed at the time of feeding, such as via a top dressing. In addition, the humates and/or modified humates may be fed to the animals either alone or in combination with other feed additive agents as a feed supplement. The amount of humate and/or modified humate which must be added to a given feed composition may vary with the type of feed composition and the specific animal being fed. Typically, the humate and/or modified humate is added to the animal feed at a dosage of from about 0.05% to about 5% by weight on a dry weight basis, preferably from about 0.1% to about 3%, and most preferably about 1% by weight on a dry weight basis. In all cases, however, effective amounts of the humate and/or modified humate must be added for optimum performance. As is well understood by those skilled in the art, the specific dosage of humate, modified humate, or any combination thereof, can be adjusted in accordance with the specific compound being administered, the problem being addressed, the animal species and other relevant facts that may modify the activity of the compounds or the response of the animal. Also, either a single daily dose or divided daily dosages may be employed, as is well known in the art.

In a method of compounding feed for animals in accordance with the present invention, the humate and/or modified humate compounds utilized are incorporated with the animal feed in the amounts described above. The feed mixture is then fed as a mash or is formed into desired discrete shapes for further processing and packaging. In general, these discrete shapes may be pellets, blocks or briquettes formed by known extrusion and/or compacting techniques. The particular processing technique utilized does not affect the performance of the humate and/or modified humate compounds in the animal feed mixture.

The use of humates and/or modified humates as described in the present invention may be further supplemented by combination with other compounds commonly used in the formulation and/or application of animal feed. Such compounds include, but are not limited to, deposition agents, binders, anti-biotics feeding attractants, dust control agents and preservatives. It will be understood by one skilled in the art, however, that such additional components are not essential to the activity of the humates and/or modified humates. Their proportions therefore, are not critical and may be optimized for the purpose and method of application by one skilled in the art.

Trial runs on hogs, dairy cows and veal calves indicate improved feed efficiency, increase in milk production and butter fat, and reductions in morbidity and mortality. In addition, the following example will serve to demonstrate the advantages and features of the present invention in reducing the odor of animal manure. This example is merely intended for illustration without in any way limiting the scope of the invention.

### EXAMPLE 1

The objective of this experiment was to determine how humate would influence manure odor of Holstein cows. Humate contains high levels of carbon, humic acid, organic matter, and an array of trace minerals. One of the primary modes of action attributed to humates is the increase in microbial activity. Increasing the number of microbes will stimulate greater breakdown of nutrients. It does not matter whether the microbe is found in the soil or the rumen of a Holstein. The following entails what actions are thought to take place when animals are fed humate:

1. The high amount of readily assimilated carbon increases microbial numbers. An enhanced microbial population allows food to be digested to a greater extent, thereby extracting more nutrients from the same amount of food. It has been observed that manure from humate fed animals has less ammonia odor and decomposes better. The apparent reason is that nitrogenous compounds which are responsible for the odor problems, combine with readily available carbon (supplied by the humate) to form proteinaceous compounds.

2. The vast array of organic acids found in humate contribute to the breakdown of food particles. These organic acids complement digestive enzymes, allowing greater digestion of the animal's feed. This translates into increased food efficiency.

3. Humate supplies an array of trace elements which are no longer found in our trace mineral deficient soils. Trace minerals enhance the immune systems, thereby enabling animals to fend off sickness and disease. Building up an animal's immune system also allows it to overcome stress.

The thirty-five Holstein cows used in this trial were in their sixth or seventh month of lactation. At this late stage of lactation it is generally difficult to stimulate an increase in production of milk. Coupling this with summer heat stress creates an arduous task for humate. When the feeding trail began, the cows were already experiencing a steady daily decline in milk production. The trial commenced with cows receiving two ounces of humate per head per day for a two-week period. Next, three ounces of humate were fed daily to each cow for an additional two weeks. The trail culminated with ingestion of four ounces of humate per head per day for another two weeks. Data was recorded every second day.

During the trail, a significant reduction in the fly population was noticed. Before the trail began, the cows were treated with a pour-on insecticide every seven days. The cost per treatment per cow was $0.56. This equates to a monthly cost of $2.24. After the trail commenced the interval between treatments increased to 17 days. At this interval it would be only cost about $1.05 per month. Continued feeding of four ounces of humate resulted in the discovery that treatment was now necessary only every thirty-two days. Since feeding humate, fly control costs dropped about 75%.

It is believed that the only plausible explanation for the aforementioned results is that since flies are attracted to manure because of its ammonia odor, the reduced odor from humate fed animals reduced the number of flies.

I claim:

1. An animal feed composition comprising:
an organic meal; and
an effective amount of a humate or modified humate to reduce manure odor, said effective amount comprises from about 0.05% to about 5.0% by weight of said humate or modified humate based on the total weight of a feed mixture.

2. The composition of claim 1 wherein said humate is obtained by extraction of humic bearing ore with alkali.

3. The composition of claim 2 wherein said humic bearing ore is a lignite, a peat, bituminous coal, brown coal, collinite, exinite, sapropelic coal, or a mixture thereof.

4. The composition of claim 1 wherein said humate is obtained by precipitation from runoff water containing high organic contents.

5. The composition of claim 1 wherein said humate is an artificial humate produced by oxidative polymerization of quinones.

6. The composition of claim 1 wherein said modified humate is obtained from oxidized lignite, peat, bituminous coal, brown coal, collinite, exinite, sapropelic coal, or a mixture thereof.

7. The composition of claim 1 wherein said modified humate is obtained by oxidizing a humate after obtaining said humate by alkali extraction of humic bearing ore.

8. The composition of claim 1 wherein said modified humate is obtained by sulfonation of a humate after obtaining said humate by alkali extraction of humic bearing ores.

9. A method of reducing the odor of animal manure, comprising the steps of:
feeding a diet containing an organic meal to an animal; and
feeding with said diet an effective amount of a humate or modified humate, said effective amount of the humate or modified humate comprises from about 0.05% to about 5.0% by weight of the diet.

10. The method of claim 9 wherein said humate or modified humate is incorporated with said organic meal when formulating said organic meal.

11. The method of claim 9 wherein said humate or modified humate is incorporated with said organic meal when feeding said organic meal to said animal.

12. The method of claim 9 wherein said humate or modified humate is fed as a top dressing on said organic meal.

13. The method of claim 9 wherein said humate is obtained by extraction of humic bearing ore with alkali.

14. The method of claim 13 wherein said humic bearing ore is a lignite, a peat, bituminous coal, brown coal, collinite, exinite, sapropelic coal, or a mixture thereof.

15. The method of claim 9 wherein said humate is obtained by precipitation from runoff water containing high organic contents.

16. The method of claim 9 wherein said humate is an artificial humate produced by oxidative polymerization of quinones.

17. The method of claim 9 wherein said modified humate is obtained from oxidized lignite, peat, bituminous coal, brown coal, collinite, exinite, sapropelic coal, or a mixture thereof.

18. The method of claim 9 wherein said modified humate is obtained by oxidizing a humate after obtaining said humate by alkali extraction of humic bearing ore.

19. The method of claim 9 wherein said modified humate is obtained by sulfonation of a humate after obtaining said humate by alkali extraction of humic bearing ores.
